(19) United States
(12) Patent Application Publication
(10) Pub. No.: US 2013/0168004 A1
(43) Pub. Date: Jul. 4, 2013

(54) METHOD AND APPARATUS FOR BONDING MEMBER

(71) Applicant: Kazuta Saito, Tokyo (JP)

(72) Inventor: Kazuta Saito, Tokyo (JP)

(73) Assignee: 3M INNOVATIVE PROPERTIES COMPANY, ST. PAUL, MN (US)

(21) Appl. No.: 13/814,272

(22) PCT Filed: Aug. 22, 2011
(86) PCT No.: PCT/US11/48556

§ 371 Date: Feb. 5, 2013

(30) Foreign Application Priority Data
Aug. 27, 2010 (JP) 2010-190869

(51) Int. Cl. B32B 37/10

(52) U.S. Cl. CPC B32B 37/10
USPC 156/60; 156/538

(57) ABSTRACT

To reliably avoid inclusion of air bubbles into adhesive when bonding a member to another member with an adhesive held between them. A first member 10 and a second member 12 are disposed at a relative position with a first surface 10a and a second surface 12a opposed to and spaced apart from each other and with a plurality of first adhesive members 14 and single second adhesive member 18 extending in directions orthogonal to each other. The second member 12 is caused to approach to the first member 10, and the second adhesive member 18 is initially brought into contact with the plurality of first adhesive members 14 between the second member 12 and the first member 10. A local pressing force P is applied to the rear surface 12b of the second member 12 to spread the single second adhesive member 18 and the plurality of the first adhesive members 14. While the pressing force P is moved along the rear surface 12b of the second member 12, amount of deflection of the second member 12 is gradually decreased so as to further spread the plurality of first adhesive members 14 between the first surface 10a and the second surface 12a.

### TECHNICAL FIELD

The present disclosure relates to a bonding method for bonding a member. The present disclosure also relates to a bonding apparatus for bonding a member.

### BACKGROUND

A method for bonding a member to another member with an adhesive held between them has been known in which inclusion of air bubbles into the adhesive can be avoided.

For example, Japanese Unexamined Patent Publication (Kokai) No. 8-209076 discloses a method and a device for bonding two flat plates to each other without including air bubbles into the adhesive. In Japanese Unexamined Patent Publication (Kokai) No. 8-209076, there is a description that an adhesive resin 3 such as ultraviolet-ray curing resin is dropped from resin imparting parts 18 and 19, respectively, onto the upper faces of a flat micro-lens 22 (flat plate 1) and the glass substrate 23 (flat plate 2) (FIG. 1(a)). Then, the glass substrate 23 is turned upside down so as to be opposed to the flat plate micro-lens 22 and an adhesive resin 3 attached in spot-like state to the glass substrate 23 is caused to be hung down in icicle-like shape (FIG. 1(b)). The glass substrate 23 is lowered while keeping this state and brought into contact with the adhesive resin 3 on the upper face of the flat plate micro-lens 22 (FIG. 1 (c)). The glass substrate 23 is further lowered and the adhesive resin 3 is caused to be spread over the entire bonding interface between the glass substrate 23 and the flat plate micro-lens 22 and, as necessary, the glass substrate 23 is pressed with a pressing section 21 so as to be brought in sufficiently close contact with the flat plate micro-lens 22 under pressure. Finally, ultraviolet rays are irradiated from an ultraviolet lamp 24 to cure the adhesive resin 3 (FIG. 1(d))” and that “as shown in FIG. 5, a lamination apparatus 43 for bonding flat plates includes a resin imparting part 32 that is capable of attaching adhesive resin 3 onto a lower surface of a glass substrate 23 supported on the upper side and a dispenser-type resin imparting part 33 that is capable of dropping adhesive resin 3 onto an upper surface of a flat micro-lens 22 supported on the lower side.

The resin imparting part 32 has a cylindrical shape with an opening on the upper end, and adhesive resin is supplied as a bulge by surface tension from the upper end opening. The adhesive resin 3 can be transferred to the lower surface of the glass substrate 23 by bringing the lower surface of the glass substrate 23 into contact with the bulge of the adhesive resin 3.

Japanese Unexamined Patent Publication (Kokai) No. 2004-296139 discloses a sticking apparatus and a sticking method for sticking together two substrates without inclusion of air bubbles into resin material between them. In Japanese Unexamined Patent Publication (Kokai) No. 2004-296139, there is descriptions that a sticking apparatus according to the present disclosure comprises a first substrate holding section for holding a first substrate having resin material disposed thereon and a second substrate holding section for holding two opposing sides of a second substrate such that the second substrate is opposed to the resin material side of the first substrate held in the first substrate holding section, and a pair of pressing sections that moves from the center portion of the second substrate to the respective opposing two sides in opposite directions to each other to imparts a pressing force to the second substrate to thereby stick the second substrate to the first substrate via resin material.” and that “the application section 220 is capable of applying resin material 30 in the shape of a plurality of consecutive lines separated from each other.” and that “with a gap G maintained between the sealing substrate 20 and the resin material 30 on the element substrate 10 by the second substrate holding section 320, a pressure is applied on the center line 23 between the opposing two sides 21, 22 of the sealing substrate 20. In this way, the center portion of the sealing substrate 20 is bent to be brought in line contact with the resin material 30 to form a line contact portion 24.

### SUMMARY

In the technology of bonding a member to another member via an adhesive (especially a normally liquid adhesive) held between them, it is desired to reliably avoid inclusion of air bubbles into the adhesive. It is also desired to simplify the construction of the bonding method and bonding apparatus for bonding a member.

One aspect of the present disclosure is a method for bonding a member, comprising arranging a plurality of first adhesive members to be spaced from each other on a first surface of a first member, each first adhesive member having a linear form; arranging a single second adhesive member on a second surface of a second member, the second adhesive member having a linear form; disposing said first member and said second member at a relative position where said first surface is opposed to and spaced from said second surface and said plurality of first adhesive members extend in a direction intersecting said second adhesive member; bending said second member at said relative position thereby contacting said single second adhesive member to said plurality of first adhesive members initially between said second member and said first member; applying a local pressing force to a rear surface opposite to said second surface of said second member to press a part of said second member onto said first member, and spreading said single second adhesive member and portions of said plurality of first adhesive members contacting said second adhesive member; shifting said local pressing force along said rear surface and gradually decreasing a deflection amount of said second member, so as to further spread said plurality of first adhesive members between said first surface and said second surface, and thereby forming a single adhesive layer between said first surface and said second surface; and solidifying said adhesive layer.

Another aspect of the present disclosure is an apparatus for bonding a member, which works the bonding method as described above, the apparatus comprising a first support section supporting said first member with said first surface, on which said plurality of first adhesive members are arranged, facing upward; a movable second support section supporting said second member with said second surface, on which said single second adhesive member is arranged, facing downward, said second support section capable of bending said second member due to gravity; a movable pressing section applying said local pressing force to said rear surface of said second member; and a control section controlling an operation of said second support section and an operation of said pressing section, wherein said second support section comprises a movable rest supporting an outer peripheral portion of said second member at a variable height position relative to said first surface of said first member, and thereby bending said second member; and a movable rest driving mechanism moving said movable rest to change a relative position between said second member and said first member, wherein said pressing section comprises a plurality of rollers rotatable independently of each other about respective rotation axes, with the rotation axes shiftable independently of each other, said plurality of rollers put on said rear surface of said second member with the respective rotation axes extending in a direction parallel to said single second adhesive member; and a roller driving mechanism moving said plurality of rollers in a parallel translation along said rear surface of said second member, wherein said control section controls said movable rest driving mechanism to make said single second adhesive member contact said plurality of first adhesive members initially between said second member and said first member, and controls said movable rest driving mechanism and said roller driving mechanism to shift said local pressing force along said rear surface and gradually decrease a deflection amount of said second member, so as to form said adhesive layer between said first surface and said second surface.

In accordance with the method for bonding a member according to the first aspect of the present disclosure, since the single second adhesive member is brought initially into contact with the plurality of first adhesive members between the first and second members to be bonded, inclusion of air bubbles into the adhesive at the initial contact points can be more effectively avoided, as compared to the bonding method in which an adhesive disposed on one member is brought initially into contact with a surface of the other member. Further, since the single second adhesive member in the linear form is brought into contact with the plurality of first adhesive members in an arrangement intersecting each other, as compared to the bonding method in which an adhesive disposed on one member is brought into contact with the adhesive disposed on other member in spots and hung in the icicle-like shape, inclusion of air bubbles can be avoided at the initial contact points uniformly for the plurality of first adhesive members arranged over broader range. Therefore, when the first member and the second member are bonded to each other via an adhesive layer held between them, inclusion of air bubbles into the adhesive layer can be more reliably avoided.

In accordance with the apparatus for bonding a member according to the second aspect of the present disclosure, too, the advantageous effect as described above of the bonding method for bonding a member can be obtained. Further, even when there is ruggedness on the rear surface of the second member due to uneven thickness, or the like, of the second member, for example, since independent displacement of rotation axes of the individual rollers can absorb the ruggedness of the rear surface of the second member while the plurality of rollers are moved in parallel translation on the rear surface of the second member, the pressing force due to weight of the individual rollers can be applied uniformly onto the rear surface of the second member. Thus, the first adhesive member can be spread uniformly over the entire area between the first surface of the first member and the second surface of the second member with inclusion of air bubbles effectively avoided.

### BRIEF DESCRIPTION OF DRAWINGS

FIG. 1 (a)-(c) A schematic view showing one step of a member bonding method according to an embodiment of the present disclosure, showing a first member to be bonded in orthographic views.

FIG. 2 (a)-(c) A schematic view showing another step of the member bonding method according to an embodiment of the present disclosure, showing a second member to be bonded in orthographic views.

FIG. 3 (a)-(c) Schematic views showing subsequent steps of the member bonding method according to an embodiment of the present disclosure, showing front elevation views of the first member and the second member together with main components of a member bonding apparatus according to an embodiment of the present disclosure.

FIG. 4 (a)-(c) Sectional views taken along the line IV-IV of FIG. 3(a) showing the steps of FIG. 3(a)-(c) with a part of the main components of the member bonding apparatus omitted.

FIG. 5 (a)-(d) Schematic views showing further subsequent steps of the member bonding method according to an embodiment of the present disclosure, showing front elevation view of the first member and the second member together with main components of the member bonding apparatus according to an embodiment of the present disclosure.

FIG. 6 (a) A schematic view showing an example of the method of forming a first adhesive member on the first member of FIG. 1; (b) A schematic view showing a modification of the method of forming the first adhesive member.

FIG. 7 A schematic view showing an example of the method of forming second adhesive members on the second member of FIG. 2.

FIG. 8 (a) A schematic view showing an example of the coating nozzle that can be used in the forming method of FIG. 7; (b) A schematic view showing a modification of the coating nozzle.

FIG. 9 A schematic sectional view showing an example of a roller that can be used in the member bonding method of FIGS. 3 to 5.

FIG. 10 A view useful for explaining the bending conditions of the second member that can be adopted in the member bonding method of FIGS. 3 to 5.

FIG. 11 A schematic view showing one step of the member bonding method according to a modification of the embodiment, showing front elevation views of the first member and the second member together with main components of the member bonding apparatus according to an embodiment of the present disclosure.

FIG. 12 A schematic view showing a step that can be additionally implemented in the member bonding method according to an embodiment of the present disclosure.

### DETAILED DESCRIPTION

Now, embodiments of the present disclosure will be described in detail below with reference to appended drawings. Throughout the drawings, corresponding constituents are denoted by common reference numerals or symbols.

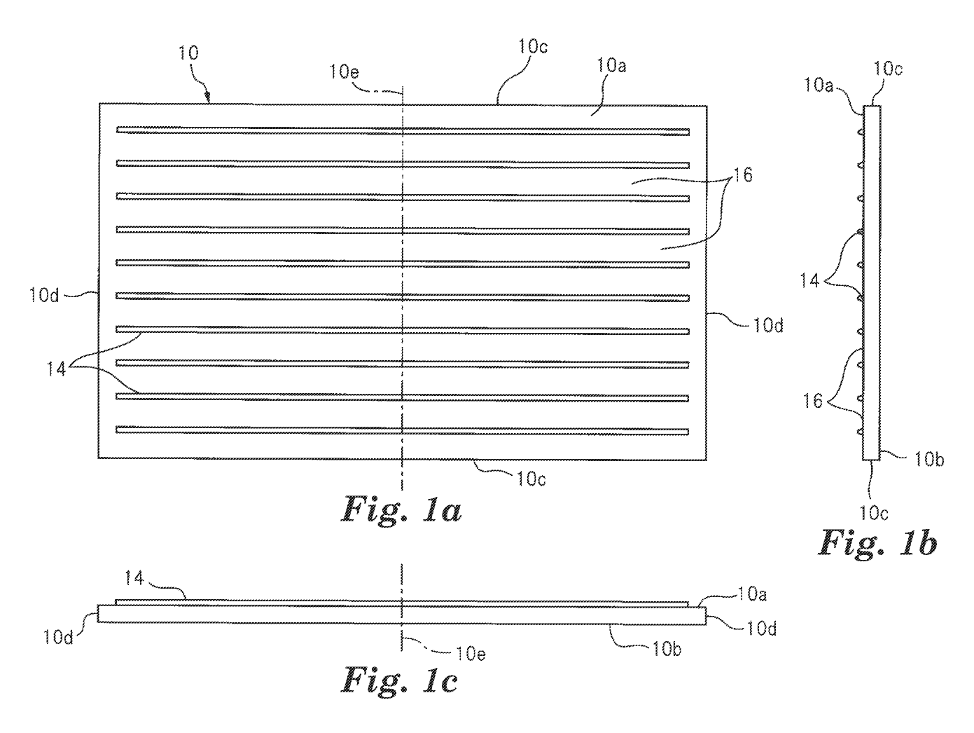

FIGS. 1 to 5 are schematic views showing the main steps of a bonding method for bonding a member according to an embodiment of the present disclosure together with main constituents of a bonding apparatus for bonding a member according to an embodiment of the present disclosure. The bonding method and the bonding apparatus shown are for bonding a first member 10 and a second member 12 with normally liquid adhesive held between them.

As shown in the orthographic view in FIG. 1, the first member 10 to which the bonding method according to an embodiment of the present disclosure is applied is a flat plate-like member of generally rectangular shape as seen in plan view, and has a generally flat first surface 10a, a rear surface 10b opposite to the first surface 10a, a pair of mutually parallel long edges 10c, and a pair of mutually parallel short edges 10d. In the bonding method shown, a plurality of first liquid adhesive members 14 each having a linear form are arranged in parallel to and spaced apart from each other on the first surface 10a of the first member 10. The first adhesive members 14 are arranged in parallel to both long edges 10c of the first member 10 and aligned at equal interval with the outermost two first adhesive members 14 arranged respectively at an arbitrary distance from the two long edges 10c. Individual first adhesive members 14 have a line symmetric form with respect to the center line 10e which passes through the center of each long edge 10c and bisects the first member 10 in longitudinal direction, and terminate at positions spaced apart at an arbitrary distance from the short edges 10d. Each of the first adhesive members 14 has a generally uniform thickness (width and height) and a dome-like cross section along the entire length. Regions 16 between adjoining first adhesive members 14 function as venting passages for avoiding inclusion of air bubbles into the first adhesive members 14 when the first member 10 and the second member 12 are bonded to each other.

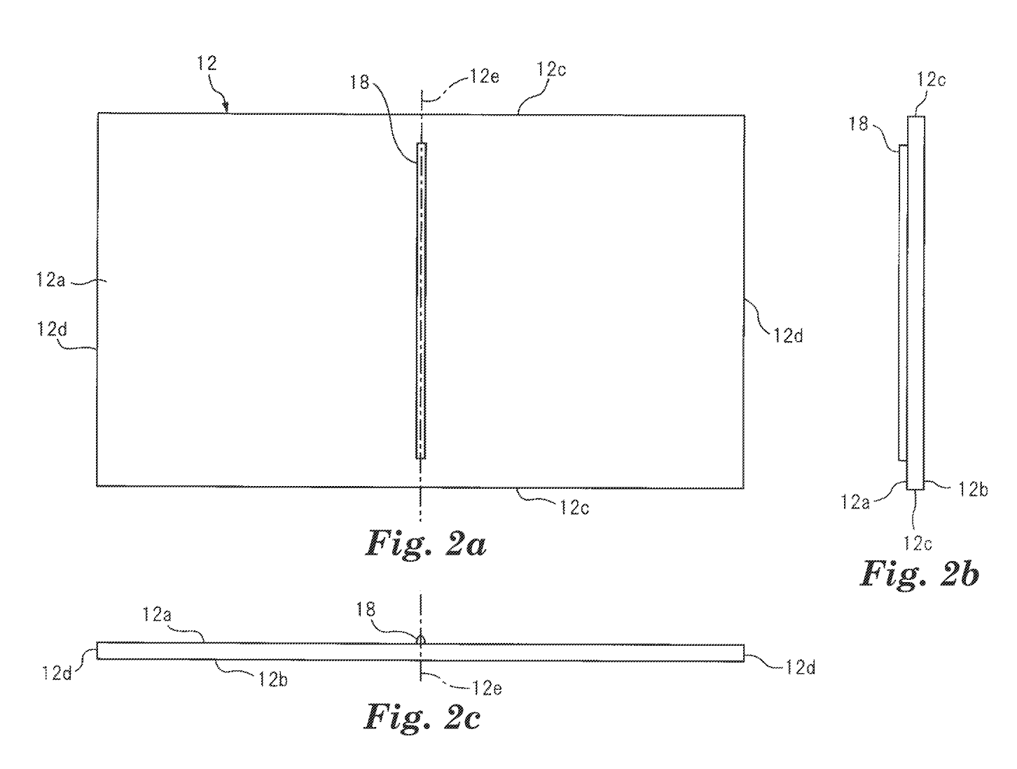

As shown in the orthographic view in FIG. 2, the second member 12 to which the bonding method according to an embodiment of the present disclosure is applied is a flat plate-like member of generally rectangular shape as seen in plan view, and has a generally flat second surface 12a, a rear surface 12b opposite to the second surface 12a, a pair of mutually parallel long edges 12c and a pair of mutually parallel short edges 12d. In the bonding method shown, a single liquid second adhesive member 18 having a linear form is arranged on the second surface 12a of the second member 12. The second adhesive member 18 is arranged in parallel to both short edges 12d of the second member 12. The second adhesive member 18 is arranged on the center line 12e which passes through the center of each long edge 12c of the second member 12 and bisects the second member 12 in the longitudinal direction, and terminates at positions spaced apart at an arbitrary distance from each long edge 12c. The second adhesive member 18 has a generally uniform thickness (width and height) and a dome-like cross section along the entire length. In the construction shown, dimensions of the long edges 12c and the short edges 12d (that is, in horizontal direction and in vertical direction as seen in plan view) of the second member 12 are, respectively, slightly larger than dimensions of the long edges 10c and the short edges 10d (that is, in horizontal direction and in vertical direction as seen in plan view) of the first member 10, and the overall length of the second adhesive 18 is slightly shorter than the short edge 10d of the first member 10.

The first and second members 10, 12 may have geometries as seen in plan view, such as squares, parallelograms, etc., other than the rectangular geometry shown in FIGS. 1 and 2. Further, the first and second members 10, 12 may have geometries generally identical to each other as illustrated, or alternatively, may have geometries and/or sizes dissimilar to each other.

The first adhesive members 14 and the second adhesive member 18 are composed of an adhesive material that is liquid in a normal state. In the bonding method shown, this adhesive has the property that it is solidified at the final step. It is also possible to compose the first adhesive members 14 and the second adhesive member 18 from adhesive material that is gradually solidified at the bonding step of bonding the first member 10 and the second member 12 to be described later. The adhesive material for the first adhesive members 14 and the second adhesive member 18 may be selected suitably from radiation (UV ray, visible light) curing type adhesives, two-component reactive type adhesives, heat curing type adhesives, and the like.

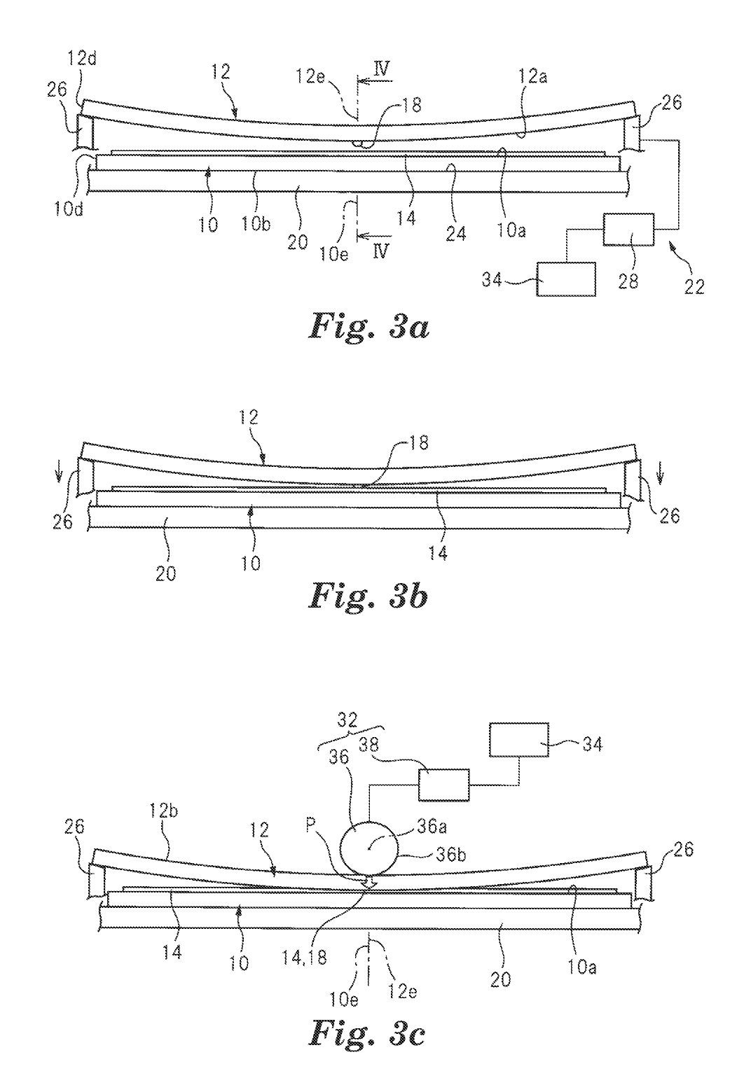

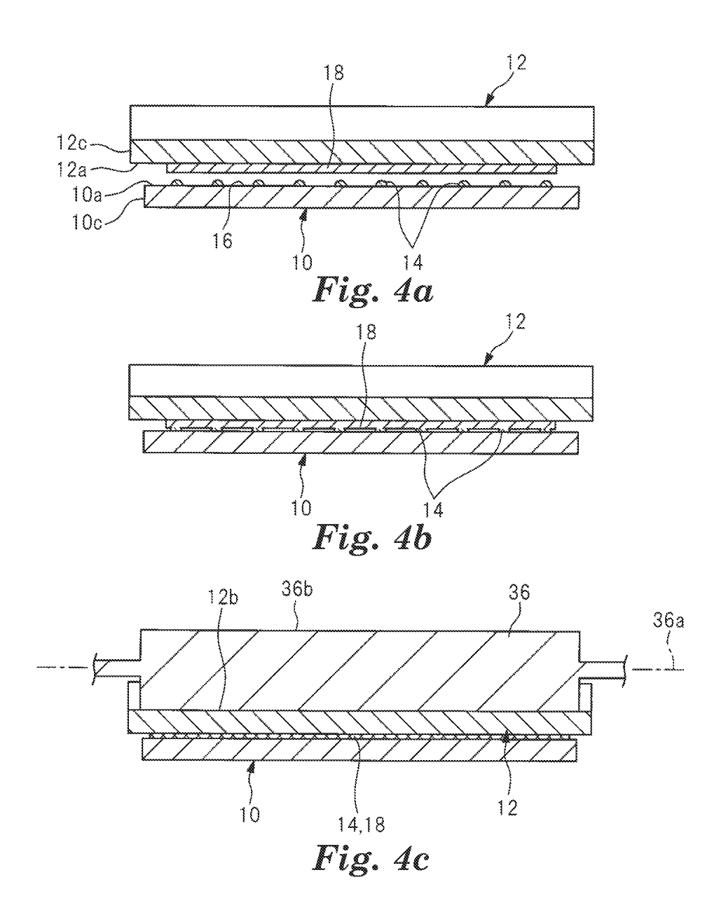

At the next step of the bonding method shown, as shown in FIGS. 3(a) and 4(a), the first member 10 and the second member 12 are disposed at a relative position where the first surface 10a is opposed to and spaced apart from the second surface 12a and the plurality of first adhesive members 14 and the single second adhesive member 18 extend in directions orthogonal to each other. More specifically, the first member 10 and the second member 12 are disposed at a relative position such that the long edges 10c and the short edges 10d of the first member 10 are respectively parallel to the long edges 12c and the short edges 12d of the second member 12, and the center line 10e of the first member 10 is parallel to and superimposed on the center line 12e of the second member 12.

The member bonding apparatus according to an embodiment of the present disclosure for implementing the bonding method shown, includes a first support section 20 for supporting the first member 10 with the first surface 10a having a plurality of first adhesive members 14 arranged thereon facing upward, and a movable second support section 22 for supporting the second member 12 with the second surface 12a having the single second adhesive member arranged thereon facing downward, and capable of bending the second member 12 due to its own weight (FIG. 3(a)). The first support section 20 has a flat supporting surface 24 to contact with generally entire rear surface 10b of the first member 10, and can support the first member 10 in the shape of flat plate at rest in horizontal mount on the supporting surface 24. The second support section 22 includes a pair of movable rests 26 for supporting the outer peripheral portion (the portion along a pair of short edges 12d) of the second member 12 at an arbitrary variable height position relative to the first surface 10a of the first member 10, and a movable rest driving mechanism 28 for moving the movable rest 26 in height direction to change the relative position between the second member 12 and the first member 10. A pair of movable rests 26 is capable of supporting the outer peripheral portion (the portion along a pair of short edges 12d) of the second member 12 to thereby bend the plate-like second member in downwardly convex form due to its own weight. The movable rest driving mechanism 28 includes a driving source such as an electric motor and an arbitrary power transmission device and is capable of moving the pair of movable rests at a desired speed independently of each other.

In the initial relative position as shown in FIGS. 3(a) and 4(a), the pair of movable rests 26 supports the portions along a pair of short edges 12d of the second member 12 at a height identical to each other, so that the region of the center line 12e of the second member 12 (and therefore the second adhesive member 18) is disposed at the lowest position (therefore at the position nearest to the first member 10). At the relative position shown, the second adhesive member 18 is disposed to intersect all of the plurality of first adhesive members 14 and extends to positions approximately directly above the two outermost first adhesive members 14.

As shown in FIGS. 3(b) and 4(b), at the next step of the bonding method shown, the pair of movable rests 26 is moved downward at an arbitrary speed and in synchronism with each other by a same distance from the initial relative position as described above by the drive of the movable rest driving mechanism 28, so that the entire second member 12 is displaced in parallel translation to approach to the first member 10, whereby the single second adhesive member 18 is brought initially into contact with the plurality of first adhesive members 14 between the second member 12 and the first member 10. Here, it is preferable that the single second adhesive member 18 is generally simultaneously brought into contact with the plurality of first adhesive members 14, and it is desirable to adjust the first support section 20 and the second support section 22 beforehand so as to improve the levelness of the first adhesive members 14 and the second adhesive member 18. However, this is not absolutely necessary, and the second adhesive member 18 may come into contact with the plurality of first adhesive members 14 with some time difference among them.

It is advantageous to control the speed of downward movement of a pair of movable rests 26 such that air is not incorporated into the adhesive members at the moment when the first adhesive members 14 and the second adhesive member 18 are brought into contact with each other. Specifically, the speed of downward movement of a pair of movable rests 26 at the moment when the second adhesive member 18 is brought into contact with individual first adhesive members 14 is preferably 0.5 mm/sec or lower, for example. If the speed of downward movement of the rest exceeds 0.5 mm/sec, air tends to be incorporated into adhesive members at the moment when the first adhesive members 14 and the second adhesive member 18 are brought into contact with each other. In order to reduce cycle time of the bonding process and to increase productivity, it is desirable to move the pair of movable rests 26 downward at a suitable speed higher than 0.5 mm/sec, until the second adhesive member 18 is brought just prior to contact with individual first adhesive members 14 so as to cause the second member 12 to rapidly approach to the first member 10, then slow down to the preferred rate of 0.5 mm/sec or lower upon bonding.

As shown in FIGS. 3(c) and 4(c), at the next step of the bonding method shown, a local pressing force (i.e. a load) P is applied to the rear surface 12b of the second member 12 in the direction for pressing a part of the second member 12 onto the first member 10, so as to spread the single second adhesive member 18 and portions of the plurality of first adhesive members 14 contacting the second adhesive member 18. In the construction shown, the pressing force P is applied uniformly to the region along the center line 12e of the second member 12 (that is, the region in which the second adhesive member 18 is situated), so that the entire second adhesive member 18 is pressed onto all the first adhesive members 14 contacting with it and onto the region along the center line 10e of the surface 10a of the first member 10. In this state, in the region along the center line 10e, 12e of the first member 10 and the second member 12, the second adhesive member 18 and the first adhesive members 14 are combined to fill the region (venting passage) 16 between the adjoining first adhesive members 14. With the construction as described above in which air is not incorporated into the adhesive members when the first adhesive members 14 and the second adhesive member 18 come into contact with each other, air can be squeezed out smoothly from the region (venting passage) 16 between the adjoining first adhesive members 14 during the subsequent period when the first adhesive members 14 and the second adhesive member 18 are subsequently pressed to each other, so that inclusion of air into the adhesive members can be avoided.

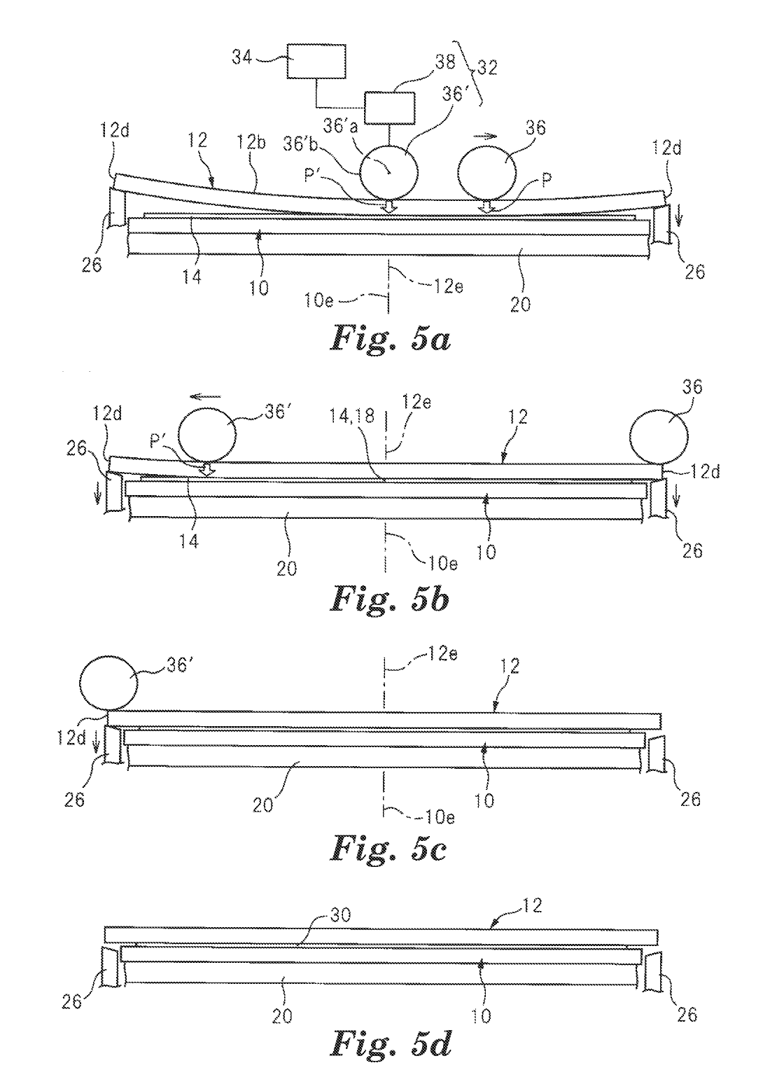

As shown in FIG. 5(a), at the next step of the bonding method shown, while the local pressing force P is shifted along the rear surface 12b of the second member 12, the amount of deflection of the second member 12 is gradually decreased to further spread the plurality of first adhesive members 14 between the first surface 10a and the second surface 12a. In the construction shown, the local pressing force P is shifted along the rear surface 12b from the region along the center line 12e of the second member 12 toward one of the short edges 12d (on the right side in the Figure) of the second member 12 in the direction parallel to the plurality of first adhesive members 14. By decreasing the amount of deflection of the right side portion (in the Figure) from the center line 12e of the second member 12 in synchronism with such shift of the pressing force P, the portion of the plurality of first adhesive members 14 on right side (in the Figure) from the center line 10e of the first member 10 can be spread while avoiding the damage of the second member 12 due to stress concentration. By constructing as described above such that air is not incorporated into the adhesive members when the pressing force P is initially applied to the region along the center line 12e of the second member 12 so as to spread the second adhesive member 18 and the contacting portion of the plurality of first adhesive members 14, during subsequent shift of the pressing force P, while squeezing air smoothly from the region (venting passage) 16 between adjoining first adhesive members 14, the first adhesive members 14 gradually fills the region (venting passage) 16 toward the right short edge 10d of the first member 10, so that incorporation of air into the adhesive members can be avoided.

While the pressing force P initially applied to the rear surface 12b of the second member 12 is shifted as described above, before the pressing force P reaches one of the short edges 12d of the second member 12, another local pressing force (that is, a load) P′ is applied to the region along the center line 12e of the rear surface 12b of the second member 12 in the direction for pressing a portion of the second member 12 to the first member 10 (FIG. 5(a)). The pressing force P′ is then shifted along the rear surface 12b from the region along the center line 12e of the second member 12 toward the other short edge 12d (on the left side in the Figure) of the second member 12 in the direction parallel to the plurality of first adhesive members 14 (FIG. 5(b)). By decreasing the amount of deflection of the portion of the second member 12 on the left side (in the Figure) of the center line 12e in synchronism with this shift of the pressing force P′, the portion of the plurality of first adhesive members 14 on the left side (in the Figure) from the center line 10e of the first member 10 can be spread further between the first surface 10a and the second surface 12a while avoiding damage of the second member 12 due to stress concentration. In this step, too, by the shifting pressing force P′, the first adhesive members 14 can gradually fill the region (venting passage) 16 toward the left short edge 10d of the first member 10 while squeezing air smoothly from the region (venting passage) 16 between adjoining first adhesive members 14, so that incorporation of air into adhesive members can be avoided.

At the same time when the initial pressing force reaches the right short edge 12d of the second member 12 (FIG. 5(b)), deflection of the right side portion from the center line 12e of the second member 12 is eliminated, and the first adhesive members 14 are spread over the entire region on the right side of the center lines 10e, 12e between the first surface 10a of the first member 10 and the second surface 12a of the second member 12 with inclusion of air bubbles effectively avoided. Then, at or nearly at the same time when the next pressing force P′ reaches the left short edge 12d of the second member 12 (FIG. 5(c)), deflection of the left side portion from the center line 12e of the second member 12 is eliminated, and the first adhesive members 14 are spread over the entire region on the left side of the center lines 10e, 12e between the first surface 10a of the first member 10 and the second surface 12a of the second member 12 with inclusion of air bubbles effectively avoided. In the vicinity of the center lines 10e, 12e, the first adhesive members 14 and the second adhesive member 18 are come into contact with each other without inclusion of air bubbles, and in accordance with the shift of the pressing forces P, P′, some of the second adhesive member 18 is spread in a form mixed with the first adhesive member 14 up to a position spaced apart from the center lines 10e, 12e.

After two pressing force P, P′ have reached successively to the left and right short edges 12d of the second member 12, the pressing force P, P′ are released, and the second member 12 is restored to the initial form with little to no deflection. In this way, single adhesive layer 30 as a mixture of the first adhesive members 14 and the second adhesive member 18 is formed between the first surface 10a of the flat plate-like first member 10 and the second surface 12a of the flat plate-like second member 12 in a state uniformly spread over the entire area with inclusion of air bubbles effectively avoided (FIG. 5(d)). In view of equalizing the thickness and the spread of the adhesive layer 30 on the left and right sides of the center lines 10e, 12e, it is desirable that the pressing forces P, P′ be of mutually same magnitude.

In order to implement the steps shown in FIGS. 3 to 5, the member bonding apparatus according to an embodiment of the present disclosure further includes a movable pressing section 32 for applying local pressing forces P, P′ to the rear surface 12b of the second member 12, and a control section 34 for controlling the operation of the second support section 22 and the operation of the pressing section 32 (FIG. 3(a), (c)). The pressing section 32 includes rollers 36, 36′ put on the rear surface 12b of the second member 12 with the rotation axis 36a disposed in the direction generally parallel to the single second adhesive member 18 (that is, in the direction generally parallel to the center line 12e of the second member 12) provided on the second member 12, and a roller driving mechanism 38 for moving the rollers 36, 36′ in parallel translation at an arbitrary speed along the rear surface 12b of the second member 12 (FIG. 3(c), FIG. 5(a)). The control section 34 controls the movable rest driving mechanism 28 of the second support section 22 to move a pair of movable rests 26 downward at a desired speed as described above so as to initially bring the single second adhesive member 18 into contact with the plurality of first adhesive members 14 between the second member 12 and the first member 10 (FIG. 3(b)).

The control section 34 also controls the movable rest driving mechanism 28 and the roller driving mechanism 38 to shift the local pressing force P, P′ along the rear surface 12b of the second member 12, and at the same time, to gradually decrease the amount of deflection of the second member 12 so as to form the adhesive layer 30 between the first surface 10b of the first member 10 and the second surface 12b of the second member 12. More specifically, to the second member 12 with the second adhesive member 18 in contact with the plurality of first adhesive members 14 (FIG. 3(b)), one roller 36 with its rotation axis 36a disposed in the direction parallel to the second adhesive member 18 is put on the region along the center line 12e of the rear surface 12b of the second member 12. At this time, the outer circumferential surface 36b of the roller 36 forms a contacting surface generally parallel to the center line 12e of the second member 12 and comes into contact with the rear surface 12b of the second member 12. Due to the weight of the roller 36, a local pressing force P is uniformly applied to the region along the center line 12e of the rear surface 12b of the second member 12 (FIG. 3(c)). The operation of putting the roller 36 on the rear surface 12b of the second member 12 can be carried out by using an unshown conveyance device or as manual operation. The pressing force P due to the weight of the roller 36 can be adjusted by applying a suitable external force to the roller 36.

From the state as described above where the roller 36 applies a pressing force P to the region along the center line 12e of the second member, the control section 34 controls the roller driving mechanism 38 to move the roller 36 in parallel translation at a suitable speed toward the right short edge 12d of the second member 12 (FIG. 5(a)). During this translation, the roller 36 rolls smoothly with the outer circumference surface 36b in contact with the rear surface 12b of the second member 12. In synchronism with this translation of the roller 36, the control section 34 controls the movable rest driving mechanism 28 to move the right rest 26 (in the Figure) downward at a suitable speed so as to gradually decrease the amount of deflection of the portion on the right side of the center line 12e of the second member 12. The control section 34 continues to carry out such synchronous control on the movable rest driving mechanism 28 and the roller driving mechanism 38 until the roller 36 reaches the right short edge 12d of the second member 12 (FIG. 5(b)). The roller driving mechanism 38 includes a driving source such as an electric motor and an arbitrary power transmission device.

While the roller 36 is being moved in parallel translation as described above, before the roller 36 reaches one of the short edges 12d of the second member 12, another roller 36′ is put on the region along the center line 12e of the rear surface 12b of the second member 12 with its rotation axis 36′ a disposed in the direction parallel to the center line 12e of the second member 12. At this time, the outer circumferential surface 36′ b of the roller 36′ forms a contacting surface parallel to the center line 12e of the second member 12 to come into contact with the rear surface 12b of the second member 12. Due to the weight of the roller 36′, a local pressing force P′ is uniformly applied to the region along the center line 12e of the rear surface 12b of the second member 12 (FIG. 5(a)). The operation of putting the roller 36′ on the rear surface 12b of the second member 12 can be carried out by using an unshown conveyance device or as manual operation. The pressing force P′ due to the weight of the roller 36′ can be adjusted by applying a suitable external force to the roller 36′.

From the state as described above where the roller 36′ applies a pressing force P′ to the region along the center line 12e of the second member 12, the control section 34 controls the roller driving mechanism 38 to move the roller 36′ in parallel translation at a suitable speed toward the left short edge 12d of the second member 12 (FIG. 5(b)). During this parallel translation, the roller 36′ rolls smoothly with the outer circumference surface 36′ b in contact with the rear surface 12b of the second member 12. In synchronism with this parallel translation of the roller 36′, the control section 34 controls the movable rest driving mechanism 28 to move the left rest 26 (in the Figure) downward at a suitable speed so as to gradually decrease the amount of deflection of the portion on the left side of the center line 12e of the second member 12. The control section 34 continues to carry out such synchronous control on the movable rest driving mechanism 28 and the roller driving mechanism 38 until the roller 36′ reaches the left short edge 12d of the second member 12 (FIG. 5(c)).

After both rollers 36, 36′ have successively reached the right and left short edges 12d of the second member 12, the rollers 36, 36′ are removed from the second member 12 and the movable rests 26 on both sides are separated from the second member 12 to restore the second member 12 to the initial form having no overall deflection. In this way, a single adhesive layer 30 is formed as a combination of the first adhesive members 14 and the second adhesive member 18 between the first surface 10a of the first member 10 in the shape of flat plate and the second surface 12a of the second member in the shape of flat plate, and is spread uniformly with inclusion of air bubbles effectively avoided.

At the next step of the bonding method shown, the adhesive layer 30 formed between the first surface 10a of the first member 10 and the second surface 12a of the second member 12 is solidified by using suitable means depending on the type of the adhesive material of the first adhesive members 14 and the second adhesive member 18. For example, if the first adhesive members 14 and the second adhesive member 18 are both formed of ultraviolet ray curing type adhesive material, the adhesive layer 30 is solidified by irradiating ultraviolet radiation to the first member 10 and the second member 12 in an assembled state as shown in FIG. 5(d)). If the first adhesive members 14 and the second adhesive member 18 are both formed of two-liquid reaction type adhesive material, the first member 10 and the second member 12 in an assembled state as shown in FIG. 5(d)) are allowed to remain as they are to solidify the adhesive layer 30. In this way, the process of bonding the first member 10 and the second member 12 is completed.

In the member bonding method and the member bonding apparatus having the construction as described above, the single second adhesive member 18 is initially brought into contact with the plurality of first adhesive members 14 between the first member 10 and the second member 12 to be bonded, so that, as compared to the bonding method (for example, the bonding method disclosed in Patent Document 2 described above) in which an adhesive disposed on one of the members is initially brought into contact with a surface of the other member, inclusion of air into the adhesive members 14, 18 at the initial contact can be more effectively avoided. Further, the single second adhesive member 18 having a linear form is brought into contact with a plurality of first adhesive members 14 each having a linear form in generally mutually orthogonal arrangement, so that, as compared to the bonding method (for example, the bonding method as disclosed in Patent Document 1 described above) in which an adhesive arranged on one of the members is brought into contact with an adhesive arranged in the form of spots on the other member and hung down in icicle-like shape, inclusion of air at the initial contact points of the plurality of first adhesive members 14 arranged over broader range can be uniformly avoided. Therefore, in accordance with the member bonding method and the member bonding apparatus having the construction as described above, when the first member 10 and the second member 12 are bonded to each other via the adhesive layer 30 held between them, inclusion of air bubbles into the adhesive layer 30 can be more reliably avoided.

The member bonding method and the member bonding apparatus having the construction as described above can be applied to, for example, to the operation of bonding a transparent flat plate-like member (i.e., a second member) such as glass plate for the purpose of protection, or the like, to a screen of a display device (i.e., a first member) such as LCD (liquid crystal display), PDP (plasma display panel), organic EL (electroluminescence) display, etc. In particular, it can be advantageously applied to the operation of bonding, to a screen of a display device of type 42 (42 inch) or larger size, a glass plate of same or larger size. In such application, the adhesive layer interposed between the screen and the glass plate has a thickness of, for example, 50 μm-200 μm, and by adopting the member bonding method and the member bonding apparatus having the construction as described above, inclusion of air bubbles can be avoided, and there is no influence on the visibility of the screen through the glass plate. The member bonding method and the member bonding apparatus described herein may be used for display sizes less than 42 inch and, e.g., greater than 12 inch.

In the member bonding method and the member bonding apparatus having the construction as described above, it is advantageous from the viewpoint of avoiding inclusion of air bubbles at the time of mutual contact that the first adhesive members 14 and the second adhesive member 18 be formed from the same adhesive material. Or, the first adhesive members 14 and the second adhesive member 18 may be formed from mutually different adhesive materials, provided that their co-solubility at the time of mutual contact can be ensured at a certain level. From the viewpoint of forming the first adhesive members 14 and the second adhesive member 18 in uniform thickness and cross-sectional shape over the entire length, and from the viewpoint of allowing the first adhesive members 14 and the second adhesive member 18 to be spread uniformly and smoothly after the mutual contact, it is desirable that the first adhesive members 14 and the second adhesive member 18 have viscosity of, for example, 1 Pa·s (1000 cP)-10 Pa·s (10000 cP), some thixotropy, and an arbitrary wettability.

It is desirable that the second adhesive member 18 be disposed in an amount suitably selected such that, at the initial relative position shown in FIGS. 3(a) and 4(a), it does not drip down from the second surface 12a of the second member 12 due to gravity. For example, the amount of the second adhesive member 18 can be selected such that the second adhesive member 18 has the thickness of about 3-10 mm in width and 0.5-5 mm in height. Optimal value of the amount of the second adhesive member 18 can be selected based on viscosity, thixotropic property, and wettability relative to the second surface 12a, etc. of the adhesive material used.

Composition and type of adhesive material for the first adhesive members 14 and the second adhesive member 18 may be suitably selected on condition that the properties described above preferably can be ensured. Adhesive materials which can be used for the first adhesive members 14 and the second adhesive member 18 and which is liquid having fluidity in a normal state include, for example, vinyl acetate based adhesive, polyvinyl alcohol based adhesive, polyvinyl acetale based adhesive, poly vinyl chloride based adhesive, acrylic adhesive, polyamide based adhesive, cellulose based adhesive, urea based adhesive, melamine based adhesive, phenol based adhesive, epoxy based adhesive, polyester based adhesive, polyurethane based adhesive, polyaromatic based adhesive, chloroprene based adhesive, nitrile rubber based adhesive, styrene based adhesive, butyl rubber based adhesive, polysulfide based adhesive, and silicone rubber based adhesive, etc.

Among them, acryl based adhesive containing 50% or more in weight of acrylic monomer and oligomer of average molecular weight of 10,000 or less can be used advantageously. Acrylic monomer and oligomer include, for example, (meth)acrylates having linear chain alkyl group such as lauryl (meth)acrylate, cetyl (meth)acrylate (n-C16), stearyl (meth)acrylate (n-C18), alkyl (meth)acrylate (n-C20), behenyl (meth)acrylate (n-C22), etc., (meth)acrylates having branched alkyl group such as 2-ethyl hexyl (meth)acrylate, isooctyl (meth)acrylate, isononyl (meth)acrylate, isodecyl (meth)acrylate, isododecyl (meth)acrylate, isotridecyl (meth)acrylate, isomyristyl (meth)acrylate, isocetyl (meth)acrylate (iso-C 16), isostearyl (meth)acrylate (iso-C 18), and 2-octyl dodecanyl (meth)acrylate (iso-C 20), alicyclic (meth)acrylates such as cyclohexyl (meth)acrylate, isobornyl (meth)acrylate, t-butyl cyclohexyl (meth)acrylate, and dicyclo pentanyl (meth)acrylate, as well as substituted acrylamides such as N,N-dimethyl acrylamide, N,N-diethyl acrylamide, acryloyl morpholine, N,N-dimethyl aminopropyl acrylamide, isopropyl acrylamide, t-butyl acrylamide, and t-octyl acrylamide.

Acrylic monomers and oligomers further include, for example, hexanediol di(meth)acrylate, neopentyl glycol di(meth)acrylate, nonanediol di(meth)acrylate, decanediol di(meth)acrylate, dodecanediol di(meth)acrylate, cyclohexane dimethanol di(meth)acrylate, cyclohexane dimethanol di(meth)acrylate, tricyclodecane dimethanol di(meth)acrylate, hydrogenated bisphenol A di(meth)acrylate, hydrogenated polybutadiene di(meth)acrylate, hydrogenated isoprene di(meth)acrylate, trimethylol propane di(meth)acrylate, etc.

Liquid adhesive material that can be used for the first adhesive members 14 and the second adhesive member 18 preferably hardens by irradiation with ultraviolet radiation or visible light, or by application of heat. In this case, the adhesive material may contain radiation (photo) polymerization initiator, thermal polymerization initiator as a component.

The first adhesive members 14 and the second adhesive member 18 can be disposed on the first surface 10a of the first member 10 and on the second surface 12a of the second member 12 by using various devices or by manual operation. For example, in accordance with a procedure for forming the plurality of first adhesive members 14 and the single second adhesive member 18 by using an coating device equipped with an coating nozzle to apply the adhesive material onto the first surface 10a and the second surface 12a, the first adhesive members 14 and the second adhesive member 18 can be disposed in uniform dimensions and shape over a wide range, so that inclusion of air at the initial contact points can be avoided uniformly over a wide range. In this case, for example, by applying the adhesive material with an unshown coating nozzle to the first member 10 mounted horizontally with the first surface 10a facing upward, the plurality of first adhesive members 14 can be formed one by one successively. Alternatively, a plurality of coating nozzle may be used to form the plurality of first adhesive members 14 simultaneously.

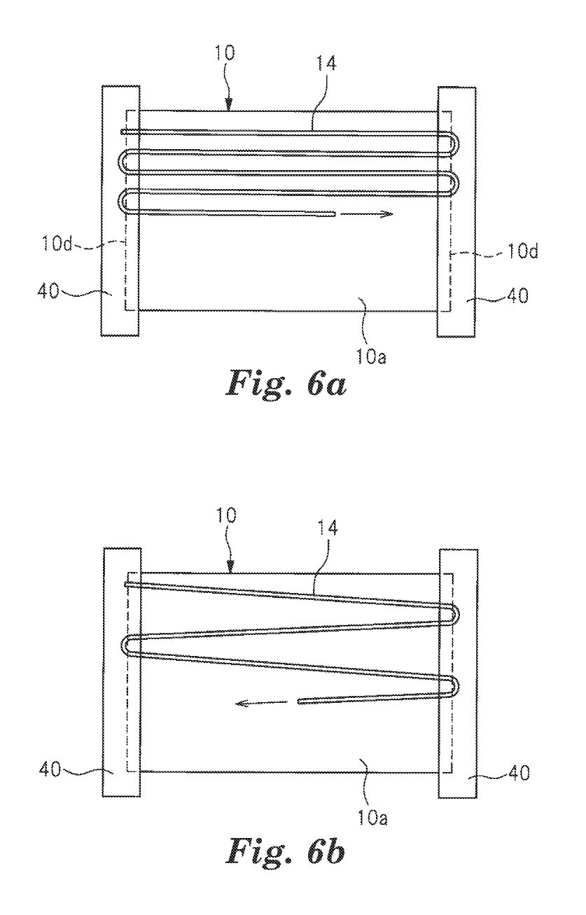

When one coating nozzle is used, as shown in FIG. 6(a), a procedure may be adopted in which, after covering regions near both short edges 10d of the first surface 10a of the first member 10 with a mask 40, the adhesive material for the first adhesive member 14 is continuously applied to the first surface 10a and the mask 40 by using one coating nozzle, and the mask 40 is removed after the application has been completed. With this procedure, time required for disposition of the first adhesive members 14 can be reduced, and in addition, supply of the adhesive material is not interrupted at both longitudinal ends of individual first adhesive member 14 so that inclusion of air bubbles during the application work can be avoided.

The plurality of first adhesive members 14 are not limited to the construction described above, and they may be constructed so as to extend in mutually slanting arrangement, provided that the region 16 which functions as a venting passage can be formed between adjoining first adhesive members 14 (that is, adjoining first adhesive members 14 do not contact with each other). In this construction, too, the application method using the mask 40 is effective, as shown in FIG. 6(b). Individual first adhesive member 14 is not limited to the linear form shown, and may have a curved form, provided that it is formed in the shape of a line with generally uniform thickness and cross-sectional shape, and that a region that functions as a venting passage can be formed between adjoining first adhesive members 14. Dimensions (thickness and length) of the first adhesive member 14, number, interval of disposition, etc. are determined by the composition and nature of the adhesive material, adhesion area of the first surface 10a of the first member 10 and the second surface 12a of the second member 12, etc.

The second adhesive member 18 can be formed by applying the adhesive material with an unshown coating nozzle to the second member 12 which is placed, for example, horizontally with the second surface 12a facing upward. But, in order to save the time and labor for turning upside down the second member 12 with the second adhesive member 18 disposed on the second surface 12a and then placing it above the first member 10, it is advantageous to form the second adhesive member 18 by supporting the second member 12 at both ends with the second surface 12a facing downward on a pair of movable rests 26 of the second support section 22, for example, and applying the adhesive material in a linear form with an coating nozzle to the region of the center line 12e of the second surface 12a bent in downwardly convex form due to its own weight.

The second adhesive member 18 is not limited to the linear form shown, and may have a curved form (for example, meandering form), provided that it has a line-like shape of generally uniform thickness and cross-sectional shape, and can be disposed substantially along the center line 12e of the second member 12. Dimensions of the second adhesive member 18 is determined by the composition and nature of the adhesive material, adhesion area of the first surface 10a of the first member 10 and the second surface 12a of the second member 12, etc. If the first adhesive members 14 extend in slanting arrangement or have a curved-line form, or if the second adhesive member 18 has a curved-line form, when the first member 10 and the second member 12 are disposed in the relative position shown in FIGS. 3(a) and 4(a), the plurality of first adhesive members 14 and the single second adhesive member 18 extend in directions intersecting each other at a suitable angle.

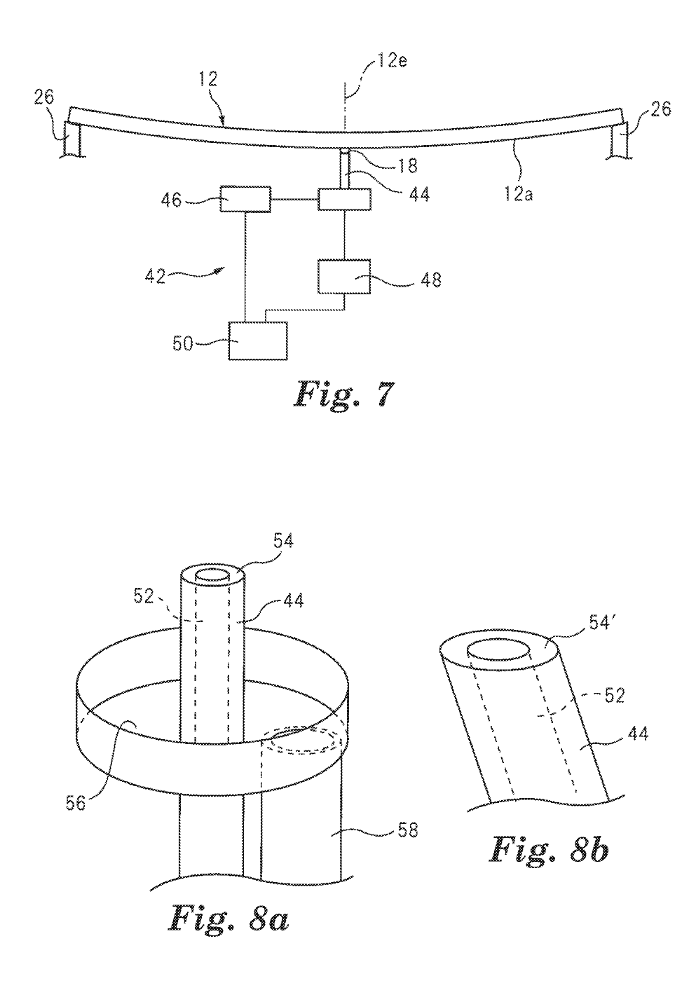

The bonding apparatus for bonding a member according to an embodiment of the present disclosure may further include, in order to carry out the operation of forming the second adhesive member 18 as described above, an coating device 42 for applying the adhesive material for the second adhesive member 18 in a linear form to the second surface 12a of the second member 12 supported on a pair of movable rests 26 of the second support section 22 with the second surface 12a facing downward, as shown in FIG. 7. The coating device 42 includes an coating nozzle 44 with the discharge port facing upward, a nozzle driving mechanism 46 for moving the coating nozzle in a straight line in the direction parallel to the second surface 12a of the second member 12, an adhesive supplying mechanism 48 for discharging a predetermined amount of adhesive material from the discharge port of the coating nozzle 44, and an application control section 50 for controlling the nozzle driving mechanism 46 and the adhesive supplying mechanism 48.

The coating nozzle 44 includes an adhesive supplying path 52 connected to the adhesive supplying mechanism 48, and an upward facing discharge port 54 having an end surface generally perpendicular to the axial direction of the adhesive supply path 52 (FIG. 8(a)). Or, the coating nozzle 44 may include an adhesive supply path 52 and an upward facing discharge port 54′ having an end surface intersecting obliquely the axial direction of the adhesive supply path 52 (FIG. 8(b)). It may further include a saucer 56 for receiving excess adhesive material which may overflows from the discharge port 54 and run down along the outer surface of the coating nozzle 44 during application operation, and a discharge tube 58 with an opening on the bottom of the saucer 56 (FIG. 8(a)).

The nozzle driving mechanism 46 includes a driving source such as an electric motor and an arbitrary power transmission device, and can move the coating nozzle 44 in a straight line in the direction parallel to the second surface 12a at an arbitrary speed with a constant gap maintained between the downward facing second surface 12a of the second member 12 and the upward facing discharge port 54, 54′ of the coating nozzle 44. The adhesive supplying mechanism 48 includes an adhesive reservoir and fluid devices such as a pump, valves, etc., and can supply the adhesive material for the second adhesive member 18 to the coating nozzle 44 at an arbitrary flow rate dependent on the composition and nature of the adhesive material, the speed of movement of the coating nozzle 44, etc. The application control section 50 controls the nozzle driving mechanism 46 and the adhesive supplying mechanism 48 to adjust the speed of movement of the coating nozzle 44, the amount of discharge of the adhesive material per unit time from the discharge port 54, 54′ of the coating nozzle 44, so as to stably form the second adhesive member 18 with desired uniform thickness (width and height) in the form of a continuous line. Here, if the speed of movement of the coating nozzle 44 is too high as compared to the amount of discharge of the adhesive material per unit time from the discharge port 54, 54′ of the coating nozzle 44, the adhesive material may be applied intermittently so that it may become difficult to form the second adhesive member 18 in the form of a continuous line. On the other hand, if the speed of movement of the coating nozzle 44 is too low as compared to the amount of discharge of the adhesive material per unit time from the discharge port 54, 54′ of the coating nozzle 44, the adhesive material may overflow from the discharge port 54 to run down on the outer surface of the coating nozzle 44 so that it may become difficult to form the second adhesive member 18 stably with desired uniform thickness (width and height).

The first adhesive members 14 and the second adhesive member 18 may also be arranged on the first surface 10a of the first member 10 and on the second surface 12a of the second member 12 by an application method other than by using an coating nozzle or by various other liquid application method such as printing method, for example, screen printing method.

In the member bonding method and member bonding apparatus having the construction as described above, inclusion of air into adhesive members at the moment of contact of the first adhesive members 14 and the second adhesive member 18 can be avoided, as described above, by selecting the speed of downward movement of a pair of movable rests 26 (and therefore, of the second member 12) at the moment of contact of the second adhesive member 18 with the individual first adhesive member 14 to be, for example, 0.5 mm/sec or lower. On the other hand, since this method is constructed such that the single second adhesive member 18 is initially brought into contact with the plurality of first adhesive members 14 between the first member 10 and the second member 12, unlike the bonding method (for example, the method as disclosed in Patent Document 2 described above) in which an adhesive arranged on one of the members is initially brought into contact with a surface of the other member, inclusion of air into the adhesive members can be avoided even if the speed of the downward movement of a pair of movable rests 26 (and therefore, of the second member 12) at the moment of contact of the second adhesive member 18 with the first adhesive member 14 is higher than 0.05 mm/sec, for example.

The second support section 22 for movably supporting the second member 12 is not limited to the construction having a movable rest 26 for supporting the second member 12 from below, and may be constructed, for example, to support the second member 12 by hanging it from above.

In the member bonding method and member bonding apparatus having the construction as described above, the greater the weight of the rollers 36, 36′, the faster the first adhesive members 14 and the second adhesive member 18 can be spread between the first surface 10a of the first member 10 and the second surface 12a of the second member 12. Therefore, the speed of parallel translation of the rollers 36, 36′ can be increased to improve productivity. Thus, it is preferable to use a metal of large specific gravity such as iron as the material for the rollers 36, 36′. In such construction, if the second member 12 is formed of brittle material such as glass, it is desirable to cover the outer circumferential surface of the rollers 36, 36′ with a soft cover such as rubber. The rollers 36, 36′ may be formed from various other materials than metal as long as the desired weight can be ensured. The speed of parallel translation of the rollers 36, 36′ can be suitably set based not only on the weight of the rollers 36, 36′, but on various parameters such as composition and nature of the first adhesive members 14 and the second adhesive member 18, material of the second member 12, etc.

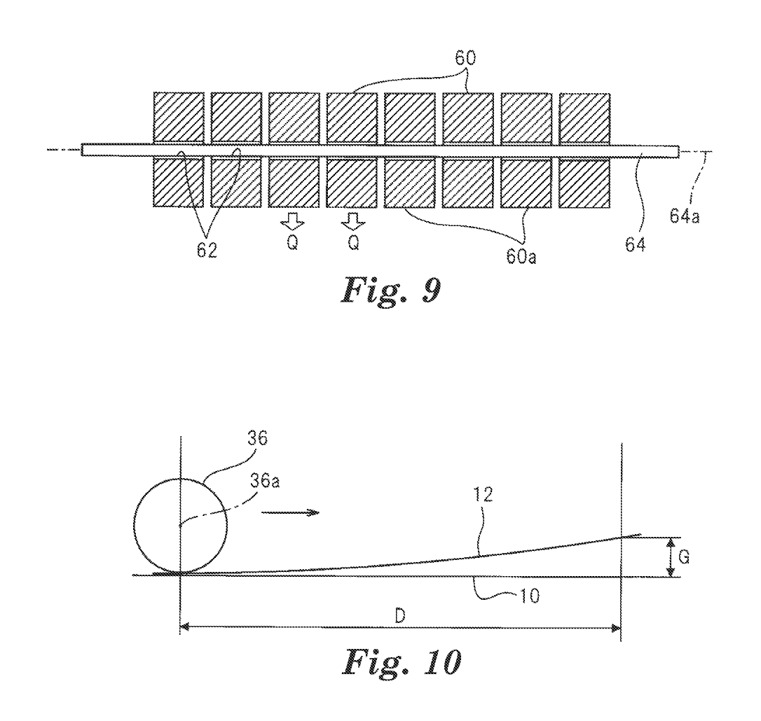

As a modification of the member bonding method and member bonding apparatus having the construction as described above, a plurality of rollers 60 that can rotate independently of each other about respective rotation axes (not shown) can be used, as shown in FIG. 9, in place of the rollers 36, 36′ described above. The plurality of rollers 60 shown, have identical dimensions, shape, and weight, and a single common shaft 64 is inserted into the center through-hole 62 via a gap. Individual rollers 60 can be displaced freely in arbitrary radial direction independently of each other with the distance between the through-hole 62 and the shaft 64 as an upper bound (thus, individual rotation axes can move in parallel translation independently of each other), so that they can rotate at the displaced positions about respective rotation axes generally parallel to the axis 64a of the shaft 64 independently of each other. Dimensions of each roller 60 may be, for example, about 50 mm in axial length and about 100 mm in diameter.

When the plurality of rollers 60 are initially put on the rear surface 12b of the second member 12, as in the case of the roller 36, rotation axes of individual rollers 60 and the axis 64a of the shaft 64 are disposed in the direction parallel to the single second adhesive member 18 provided on the second member 12 (that is, in the direction parallel to the center line 12e of the second member 12), and the plurality of rollers 60 are arranged in alignment in the direction of rotation axes. Then, while a local pressing force P is applied with the plurality of rollers 60 to the rear surface 12b of the second member 12 (FIG. 3(c)), the roller driving mechanism 38 is controlled to move the shaft 64 and the plurality of rollers 60 collectively in parallel translation toward the right short edge 12d of the second member 12 at a suitable speed (FIG. 5(a)). Similarly, when a plurality of rollers 60 are used in place of a succeeding roller 36′, the roller driving mechanism 38 is controlled to move the shaft 64 and the plurality of rollers 60 collectively in parallel translation toward the left short edge 12d of the second member 12 at a suitable speed (FIG. 5(b)). During this parallel translation, the plurality of rollers 60 roll smoothly with individual outer circumferential surfaces 60a (FIG. 9) in contact with the rear surface 12b of the second member 12, and when there is ruggedness in the rear surface 12b, they are displaced freely in arbitrary radial direction independently of each other in accordance with the ruggedness.

In accordance with the construction as described above, even if there is ruggedness in the rear surface 12b due to uneven thickness of the second member 12, while the plurality of rollers 60 are moved in parallel translation on the rear surface 12b of the second member 12, the ruggedness of the rear surface 12b of the second member 12 can be absorbed by free displacement of individual rollers 60 independent of each other in arbitrary radial direction relative to the shaft 64, so that the pressing force Q due to weight of individual rollers 60 (Q=P/number of rollers 60) can be uniformly applied to the rear surface 12b of the second member 12. As a result, the first adhesive members 14 can be spread uniformly between the first surface 10a of the first member 10 and the second surface 12a of the second member 12 so that inclusion of air bubbles can be effectively avoided. This construction is also effective even when the first surface 10a of the first member 10 has poor flatness. The rollers 60 may be formed of different materials or in different dimensions, provided that the plurality of rollers 60 have same density. It is also possible to construct such that, in place of the common shaft 64, each roller 60 has its own shaft with the premise that individual rollers can freely and independently be displaced in arbitrary radial direction.

In the member bonding method and member bonding apparatus having the construction as described above, while the rollers 36, 36′, 60 are moved in parallel translation on the rear surface 12b of the second member 12, the movable rest 26 is moved downward at suitable speed so as to gradually decrease the amount of deflection of the second member 12. At this time, as shown schematically in FIG. 10, it is desirable to control the movable rest driving mechanism 28 such that the gap G between the first member 10 and the second member 12 at the position at distance D as seen in the roller movement direction from the rotation axis 36a of the roller 36 be 0.02<G/D<0.2. However, while the rotation axis 36a of the roller 36 is at position 100 mm or longer from the short edge 12d of the second member 12, D is a constant value, D=100 (mm). If G/D is 0.2 or larger, and if the second member 12 is formed of brittle material such as glass, the second member may be damaged. On the other hand, if G/D is 0.02 or less, while the rollers 36, 36′, 60 are moved in parallel translation on the rear surface 12b of the second member 12 to spread the first adhesive members 14 and the second adhesive member 18, possibility of air incorporated into the adhesive is increased.

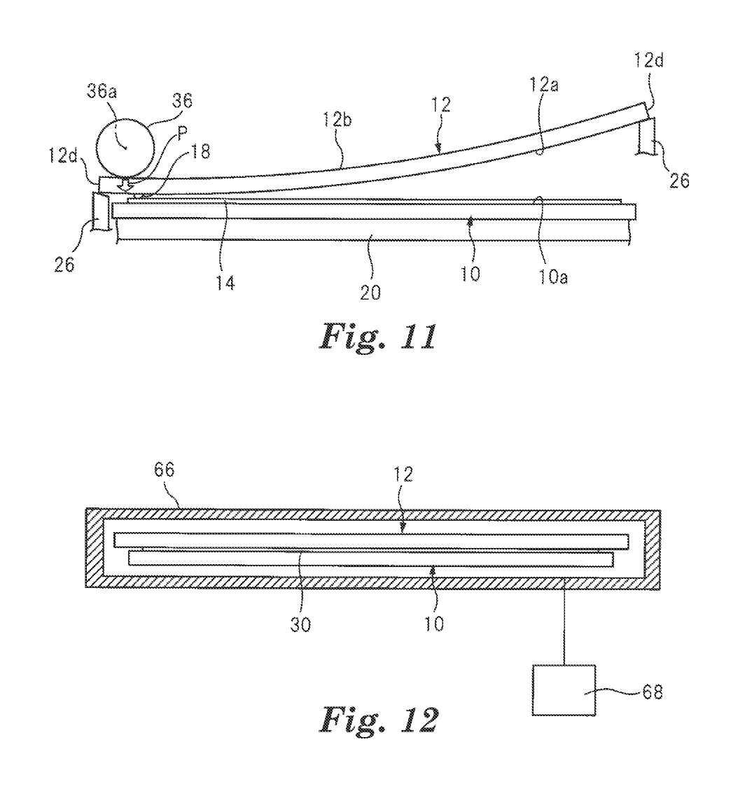

Another modification of the member bonding method and member bonding apparatus having the construction as described above, may be constructed such that, as shown in FIG. 11, the single second adhesive member 18 having a linear form is arranged on the region along one of the short edges 12d of the second surface 12a of the second member 12, and the pressing force P (that is, the roller 36) is moved from the region along one of the short edges 12d of the rear surface 12b of the second member 12 toward the other short edge 12d. In this construction, when the first member 10 and the second member 12 are disposed at the initial relative position described above, while one of the movable rests 26 supports the short edge 12b proximate to the second adhesive member 18 of the second member 12 at an arbitrary height, the other movable rest 26 supports the short edge 12d far from the second adhesive member 18 of the second member 12 at a position higher than the one movable rest 26 by the separation G falling within the range described above, so that the region of the second adhesive member 18 of the second member 12 is disposed at the lowest position (that is, nearest to the first member 10). From this relative position, both movable rests 26 are synchronously moved downward so that the second adhesive member 18 is initially brought into contact with the plurality of first adhesive members 14 between the second member 12 and the first member 10. The roller 36 is put on the rear surface 12b of the second member 12 to apply a local pressing force P, and while the pressing force P (roller 36) is moved toward the other short edge 12d of the rear surface 12b of the second member 12, the other movable rest 26 is moved downward to gradually decrease the amount of deflection of the second member 12. The bonding method and bonding apparatus according to this modification has the advantage that the construction is simplified as compared to the member bonding method and member bonding apparatus as shown in FIGS. 1 to 5.

In the member bonding method and member bonding apparatus having the construction as described above, as an additional step before solidifying the adhesive layer 30, the step of pneumatically pressurizing the first member 10 and the second member 12 with the adhesive layer formed between the first surface 10a and the second surface 12a collectively at a specified pressure, may be carried out. In this additional step, as shown in FIG. 12, for example, the first member 10 and the second member 12 with the adhesive layer 30 formed between them are collectively contained in a sealed container, and internal pressure in the container is increased by a compressor 68 or the like to the atmospheric pressure or higher (preferably twice the atmospheric pressure or higher), and after this air pressure is maintained for some suitable period, the internal pressure is returned to the atmospheric pressure. With this step, micro-air bubbles that may have been included into the adhesive layer 30 are eliminated completely by dissolving the air in the air bubbles in the adhesive layer 30.

The first member 10 and the second member 12 to which the member bonding method and member bonding apparatus having the construction as described above can be applied are not limited to members in the form of flat plate, but may include members having locally or entirely curved surface as the first surface 10a and the second surface 12a. In particular, the first member 10 may be a block-like member with thickness larger than the dimension of the first surface 10a.

1. A method for bonding a member, comprising:
arranging a plurality of first adhesive members to be spaced from each other on a first surface of a first member, each first adhesive member having a linear form;
arranging a single second adhesive member on a second surface of a second member, the second adhesive member having a linear form;
disposing said first member and said second member at a relative position where said first surface is opposed to and spaced from said second surface and said plurality of first adhesive members extend in a direction intersecting said second adhesive member;
bending said second member at said relative position thereby contacting said single second adhesive member to said plurality of first adhesive members initially between said second member and said first member;
applying a local pressing force to a rear surface opposite to said second surface of said second member to press a part of said second member onto said first member, and spreading said single second adhesive member and portions of said plurality of first adhesive members contacting said second adhesive member;
shifting said local pressing force along said rear surface and gradually decreasing a deflection amount of said second member, so as to further spread said plurality of first adhesive members between said first surface and said second surface, and thereby forming a single adhesive layer between said first surface and said second surface; and
solidifying said adhesive layer.

2. The method according to claim 1, comprising arranging said plurality of first adhesive members to be spaced in parallel from each other on said first surface of said first member, each first adhesive member having a straight line form; arranging said single second adhesive member on said second surface of said second member, the second adhesive member having a straight line form; disposing said first member and said second member at said relative position where said plurality of first adhesive members extend in a direction orthogonal to the extending direction of said second adhesive member; and shifting said local pressing force along said rear surface in a direction parallel to an extending direction of said plurality of first adhesive members.

3. The method according to claim 1, wherein arranging a single second adhesive member comprises applying said second adhesive member in the linear form on said second surface of said second member with said second surface facing downward.

4. The method according to claim 1, wherein applying a local pressing force comprises providing a plurality of rollers, each roller having a rotation axis extending parallel to said single second adhesive member, in a manner rotatable independently of each other and lying side-by-side with each other in a rotation axis direction, and applying said local pressing force by said plurality of rollers to said rear surface of said second member.

5. The method according to claim 1, further comprising, before solidifying said adhesive layer, pneumatically pressurizing entirely said first member and said second member with said adhesive layer formed between said first surface and said second surface.

6. An apparatus for bonding a member, said apparatus working the method according to claim 1, comprising:
a first support section supporting said first member with said first surface, on which said plurality of first adhesive members are arranged, facing upward;
a movable second support section supporting said second member with said second surface, on which said single second adhesive member is arranged, facing downward, said second support section capable of bending said second member due to gravity;
a movable pressing section applying said local pressing force to said rear surface of said second member; and
a control section controlling an operation of said second support section and an operation of said pressing section,
wherein said second support section comprises:
a movable rest supporting an outer peripheral portion of said second member at a variable height position relative to said first surface of said first member, and thereby bending said second member; and
a movable rest driving mechanism moving said movable rest to change a relative position between said second member and said first member,
wherein said pressing section comprises:
a plurality of rollers rotatable independently of each other about respective rotation axes, with the rotation axes shiftable independently of each other, said plurality of rollers put on said rear surface of said second member with the respective rotation axes extending in a direction parallel to said single second adhesive member; and
a roller driving mechanism moving said plurality of rollers in a parallel translation along said rear surface of said second member,
wherein said control section controls said movable rest driving mechanism to make said single second adhesive member contact said plurality of first adhesive members initially between said second member and said first member, and controls said movable rest driving mechanism and said roller driving mechanism to shift said local pressing force along said rear surface and gradually decrease a deflection amount of said second member, so as to form said adhesive layer between said first surface and said second surface.

7. The apparatus according to claim 6, further comprising a coating device applying said second adhesive member in the linear form on said second surface of said second member supported on said second support section, wherein said coating device comprises a coating nozzle with a discharge port facing upward, a nozzle driving mechanism shifting linearly said coating nozzle in a direction parallel to said second surface of said second member, an adhesive supplying mechanism making said coating nozzle discharge a predetermined amount of adhesive from said discharge port.
